(19) United States
(12) Patent Application Publication
(10) Pub. No.: US 2010/0135107 A1
(43) Pub. Date: Jun. 3, 2010

(54) Versatile Apparatus for Evenly Mixing and Dropping Raw Materials

(76) Inventor: Silong Li, Shanghai (CN)

Correspondence Address: Hiroe & Associates;Taras P. Bemko, 4-3, Usa 3-chome, Gifu-city, 500-8368, JP

(21) Appl. No.: 12/618,778

(22) Filed: Nov. 15, 2009

Related U.S. Application Data
(63) Continuation of application No. PCT/CN2008/000826, filed on Apr. 22, 2008.

(30) Foreign Application Priority Data
May 15, 2007 (CN) CN200710040647.7

(51) Int. Cl. B01F 15/02; B01F 7/00

(52) U.S. Cl. 366/189

(57) ABSTRACT

The present invention relates to a versatile apparatus for evenly mixing and dropping raw materials, comprises a barrel for mixing raw materials, an agitating device, a mechanism for dropping raw materials, a power driving and controlling mechanism, and a base. The barrel includes a body, a lid and a bottom. The lid has an inlet. Holes for installing a revolution shaft are symmetrically provided on left side wall and right side wall. The bottom has an outlet. A revolution shaft with short arm blades and long arm blades is laterally provided in the barrel. The bottom forms by intersection front and back crown faces continuously provided under front side wall and back side wall with left and right extended surfaces provided under left side wall and right side wall. The outlet is actually the middle crevice of the front and back crown faces. Because short arm blades and long arm blades are coaxially provided on the agitating device and the rotation radius of the long arm blades is corresponding to the curvature radius of the front and back crown faces, the working curved surface of long arm blades is corresponding to the front and back crown faces. Thus the ingredients can be mixed fully without the case that the ingredients directly fall and mix unevenly and the case that the ingredients cannot be completely dropped, affect the proportion of the ingredients, and finally affect the quality of products.

### RELATED APPLICATION

This application is a continuation of International Application PCT/CN2008/000826, with an international filing date of Apr. 22, 2008, now pending, which claims priority to Chinese Application CN200710040647.7, having a filing date of May 15, 2007, now pending, all of which are hereby incorporated herein by reference.

### FIELD OF THE INVENTION

The present invention relates to a technical field of mechanics, particularly to a versatile apparatus for evenly mixing and dropping raw materials, which has characters of evenly mixing raw materials and completely dropping raw materials.

### BACKGROUND OF THE INVENTION

In many professional fields such as chemical industry, plastic manufacture processing, medicine manufacture, and food processing, it is routine work to mix raw materials after allocating them according to the particular proportion generally by a traditional mixer with a common feed opening, such as a type of barrel body automatically turning over, a type of roller, and a type of erectly agitating. These apparatuses for mixing raw materials have respective characteristics working styles and functional characters, in which: the apparatuses of barrel body automatically turning over type and roller type have no agitating device, and mix the ingredients only by turning over barrel body, which appropriately apply to mix granulated ingredients. It would be easy to cause unevenly mixing and raw materials incompletely dropping if they are used to mix the raw materials including powdery ingredients. Because of providing short arm blades in the barrel cavity, the apparatus of erectly agitating type is versatile, which is fit for mixing both granulated ingredients and the raw materials including powdery ingredients. However, because the short arm blades are provided on the central upright shaft and are far away from the bottom of the barrel by the way of tilting propeller, the ingredients in the central part of the barrel during the operation can be fully and evenly agitated, but the blades are not easy to contact the ingredients gradually dropping down the bottom of the barrel in the progress of dropping or agitating and easy to form the corner pocket. Because of the continuous operation of the mixer, the ingredients in the bottom of the barrel will become more and more and even lead to the case that the ingredients adhere to the bottom of the barrel and form the dirt being difficult to fall from the barrel. The above cases will inevitably affect the actual proportion of ingredient in the operation process, and will make the proportion of the ingredients be error, and will finally affect the stability of the product quality. Therefore the current mixers commonly have the shortcomings of little versatility, bad mixture uniformity and incompletely dropping raw materials.

### SUMMARY OF THE INVENTION

The object of the present invention is to provide a novel and versatile apparatus for evenly mixing and complete dropping raw materials, which has advantages of reasonable structure, evenly mixing raw materials and completely dropping raw materials during the operation.

In accordance with the invention, this versatile apparatus for evenly mixing and dropping raw materials comprises a barrel for mixing raw materials, an agitating device, a mechanism for dropping raw materials, a power driving and controlling mechanism, and a base. The barrel for mixing raw materials includes a body, a lid and a bottom. The said body has a rectangle tub-shaped main part and comprises front side wall, back side wall, left side wall and right side wall. The lid has an inlet and a hole for connecting and installing. Holes for installing a revolution shaft are symmetrically provided on the left side wall and the right side wall. The bottom has an outlet. The said agitating device comprises a revolution shaft provided between the left side wall and the right side wall of the body, and short arm blades and long arm blades which are staggered on the revolution shaft. The number of the long arm blades and the short arm blades is defined according to request. The said mechanism for dropping raw materials is actually the bottom which is continuously provided under the body and has an outlet. The said bottom is formed by the intersection of front and back crown faces continuously provided under the front side wall and the back side wall with left and right extend surfaces provided under the left side wall and the right side wall. The said outlet is provided on intersection of the front and back crown faces and assumes a strip slotted hole shaped and is actually the interstice between the front and back crown faces. The center of the circle to curvature radius of the said front and back curved surfaces coincides with the axle center of the revolution shaft. And the radius of curvature of the front and back crown faces is corresponding to the total length of the said long arm blade from its axle center. The said power driving and controlling mechanism comprises a driving motor, a reduction gear, and a controlling switch. The said base is provided under the bottom and has a cup-shaped main part with a channel for dropping raw materials in it. The said base comprises a holder cup, a holder neck, and a bracket. The said holder cup provided closely together with the bottom assumes loudspeaker-shaped and comprises a composite strengthen laminate closely adhered to the front and back crown faces and left and right inclined walls adjacent to left side wall and right side wall. The holder neck provided under the holder cup assumes a tetragonal structure in which has a hollow channel for dropping raw materials. There is a controllable baffle laterally provided between the left and right side walls or the front and back side walls of the middle and bottom of the holder neck for completely cutting off the channel. The said bracket is provided at the most underneath and is actually an installing base plate with a hole or groove for limiting assembly location. Moreover, the said holes for installing a revolution shaft symmetrically provided on the left side wall and the right side wall are achieved by a hole for installing a bearing with the bearing provided on one side wall of the said left side wall and right side wall, and a hole for installing a flange provided on the other side wall of the said left side wall and right side wall, and a hole for installing a bearing which has bearing lid and a bearing and which provided on a flange plate matching with above flange. The said short arm blades are staggered in the form of propeller. And the working sides of the long arm blades are parallel to the revolution shaft. Many short arm blades and long arm blades provided in the form of stagger depends on request so that the covering width of them coincides with the inner width of front and back side walls of the body. The upward cavity formed by providing the controllable baffle for completely cutting off the hollow channel for dropping raw materials on the middle and bottom of the holder neck can be used as a transition cavity for temporarily depositing the mixed raw materials.

In the operation, the versatile apparatus for evenly mixing and dropping raw materials according to the present invention is assembled between the device of previous mixing ingredients and the device of posterior using ingredients by the hole for connecting and installing on the lid and the hole or groove for limiting assembly location provided on the installing base plate of the bracket. The power driving and controlling mechanism drives the agitating device by the reduction gear. The completely evenly ingredients which come from the inlet and is formed by turning and agitating through the short arm blades and the long arm blades of the agitating device get into the channel for dropping raw materials through the outlet. Alternatively, the ingredients are directly sent out to apply or deposited in the transition cavity for temporarily depositing the mixed raw materials of the holder neck for temporarily storage or sending out to apply.

Based on the above idea, in the versatile apparatus for evenly mixing and dropping raw materials according to the present invention, because the short arm blades and long arm blades are coaxially provided in the agitating device and the curvature radius of the front and back crown faces coincides with the total length of the said long arm blade from its axle center, the working curved surface of long arm blades is corresponding to the front and back crown faces of bottom. Thus in the operation the ingredients coming from an inlet of the lid can be mixed fully without the case that the ingredients directly drop and unevenly mix in the current apparatus and without the case that the ingredients cannot be completely dropped with result that has inevitably an effect on the proportion of the ingredients and has finally an effect on the quality of products. Moreover, because the transition cavity for temporarily depositing the mixed raw materials has a controllable baffle on the channel for dropping raw materials in the holder neck, it is easy to control using the ingredients according to request and real-time control the operation of the versatile apparatus for evenly mixing and dropping raw materials according to the present invention with result that it can be directly used or be used before storing or be used while working. This apparatus has obvious conveniences and operation flexibility.

It can be applying to both scientific experiments and continuous manufacture. This apparatus has simple structure, working reliability, and is easy to set up when used with the other measure ingredient system and feed system. Thus, it has strong usability, good efficiency, and broad market application prospect.

### BRIEF DESCRIPTION OF THE DRAWINGS

FIG. 1 is a perspective view showing the whole structure of the apparatus in accordance with an embodiment of the present invention;

FIG. 2 is a perspective view showing the inner structure of the apparatus in accordance with an embodiment of the present invention;

FIG. 3 is a perspective view showing the shell of the apparatus in accordance with an embodiment of the present invention.

In the figures:

```
  1. barrel for mixing raw materials
  2. agitating device
  3. mechanism for dropping raw materials
  4. power driving and controlling mechanism
  5. base
  6. body
  7. lid
  8. bottom
  9. front side wall
10. back side wall
11. left side wall
12. right side wall
13. inlet
14. hole for connecting and installing
15. hole for installing a revolution shaft
16. outlet
17. revolution shaft
18. short arm blade
19. long arm blade
20. front and back curved surfaces
21. left and right extended surfaces
22. driving motor
23. reduction gear
24. controlling switch
25. hollow channel for dropping raw materials
26. holder cup
27. holder neck
28. bracket
29. composite strengthen laminate
30. left and right inclined walls
31. controllable baffle
32. hole or groove for limiting assembly location
33. installing base plate
34. hole for installing a bearing
35. hole for installing a flange
36. flange plate
37. bearing lid
```

### DETAILED DESCRIPTION OF THE PREFERRED EMBODIMENTS

Hereinafter, the present invention will be described with reference to the accompanying drawings and a typical embodiment.

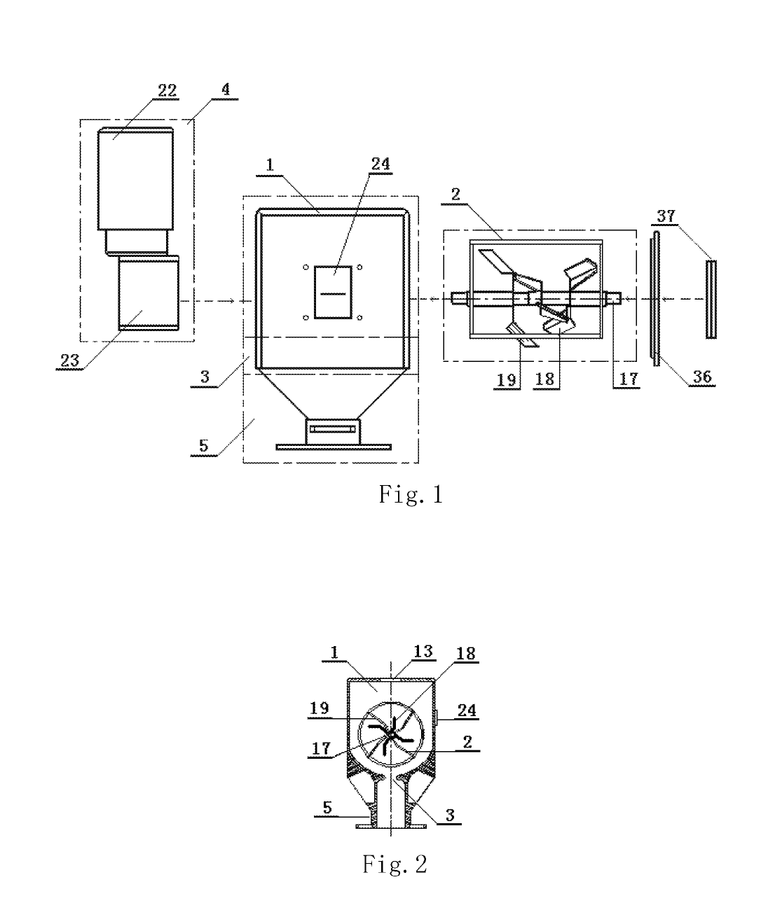

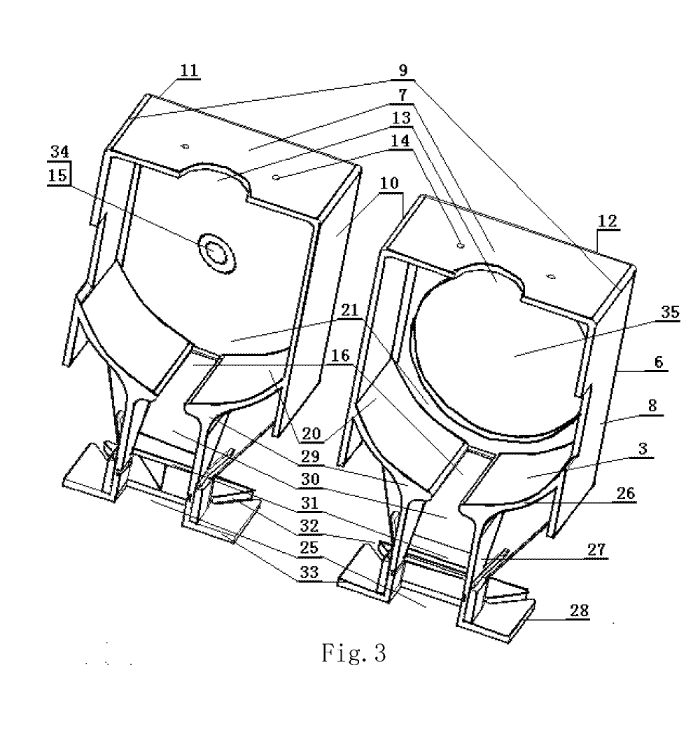

In FIG. 1, 2, 3, the versatile apparatus for evenly mixing and dropping raw materials according to the present invention comprises a barrel 1 for mixing raw materials, an agitating device 2, a mechanism 3 for dropping raw materials, a power driving and controlling mechanism 4, and a base 5. The barrel 1 for mixing raw materials includes a body 6, a lid 7 and a bottom 8. The said body 6 has a rectangle tub-shaped main part and comprises front side wall 9, back side wall 10, left side wall 11 and right side wall 12. The lid 7 has an inlet 13 and a hole for connecting and installing 14. Holes for installing a revolution shaft 15 are symmetrically provided on the left side wall 11 and right side wall 12. The bottom 8 has an outlet 16. The said agitating device 2 comprises a revolution shaft 17 and short arm blades 18 and long arm blades 19. The revolution shaft 17 is provided between the left side wall 11 and the right side wall 12 of the body 6. The short arm blades 18 and long arm blades 19 are provided in the staggered form on the revolution shaft 17. The number of the long arm blades 19 and the short arm blades 18 is defined according to the request. The said mechanism for dropping raw materials 3 is actually the bottom 8. The bottom 8 is continuously provided under the body 6 and has an outlet 16. The said bottom 8 is formed by the intersection of the front and back crown faces 20 with left and right extend surfaces 21. The front and back crown faces 20 are continuously provided under the front side wall 9 and the back side wall 10. The left and right extend surfaces 21 are provided under the left side wall 11 and the right side wall 12. The said outlet 16 is provided on intersection of the front and back crown faces 20 and assumes a strip slotted hole shaped and is actually the interstice between the front and back crown faces 20. The center of the circle to curvature radius of the said front and back curved surfaces 20 coincides with the axle center of the revolution shaft 17. And the radius of curvature of the front and back crown faces 20 is corresponding to the total length of the said long arm blade 19 from its axle center. The said power driving and controlling mechanism 4 comprises a driving motor 22, a reduction gear 23, and a controlling switch 24. The said base 5 is fixed under the bottom 8. The said base 5 has a cup-shaped main part. The main part has a channel for dropping raw materials 25 in it. The said base 5 comprises a holder cup 26, a holder neck 27, and a bracket 28. The said holder cup 26 provided closely together with the bottom 8 assumes loudspeaker-shaped. The said holder cup 26 comprises a composite strengthen laminate 29 and left and right inclined walls 30. The composite strengthen laminate 29 is closely adhered to the front and back crown faces 20. The left and right inclined wall 30 is adjacent to the left side wall 11 and the right side wall 12. The holder neck 27 provided under the holder cup 26 assumes a tetragonal structure in which has a hollow channel for dropping raw materials 25. A controllable baffle 31 is laterally provided between the left and right side walls or the front and back side walls of the middle and bottom of the holder neck 27 for completely cutting off the hollow channel for dropping raw materials 25. The said bracket 28 is provided at the most underneath and is actually an installing base plate 33 with a hole or groove for limiting assembly location 32. Moreover, the said holes for installing a revolution shaft 15 is symmetrically provided on the left side wall 11 and the right side wall 12. The said holes for installing a revolution shaft 15 is achieved by a hole for installing a bearing 34 with the bearing is provided on one side wall of the said left side wall 11 and right side wall 12, and a hole for installing a flange 35 provided on the other side wall of the said left side wall 11 and right side wall 12, and a hole for installing a bearing 33 which has bearing lid 37 and a bearing and is provided on a flange plate 36 matching with above flange. The said short arm blades 18 are staggered in the form of propeller. And the working sides of the long arm blades 19 are parallel to the revolution shaft 17. Two short arm blades 18 and long arm blades 19 provided in the form of stagger. The controllable baffle 31 for completely cutting off the hollow channel 25 dropping raw materials is provided on the middle and bottom of the holder neck 27.

1. A versatile apparatus for evenly mixing and dropping raw materials comprises a barrel for mixing raw materials (1), an agitating device (2), a mechanism for dropping raw materials (3), a power driving and controlling mechanism (4), and a base (5), characterized in:
a. the barrel for mixing raw materials (1) includes: a body (6) which has a rectangle tub-shaped main part and comprises front side wall (9), back side wall (10), and left side wall (11) and right side wall (12) in which holes for installing a revolution shaft (15) are symmetrically provided; a lid (7) which provides an inlet and a hole for connecting and installing (14); and a bottom (8) providing an outlet (16);
b. the agitating device (2) comprises: a revolution shaft (17) provided between left side wall (11) and right side wall (12) of the body (6); and short arm blades (18) and long arm blades (19) which are staggered on the revolution shaft (17);
c. the mechanism for dropping raw materials (3) actually is the bottom (8), which is formed by intersection of the front and back crown faces (20) which have the center of the circle of curvature radius coinciding with the axle center of the revolution shaft (17) and which continuously provide under the front side wall (9) and back side wall (10) with the left and right extend surfaces (21) continuously provided under the left side wall (11) and the right side wall (12), and which has a strip slotted hole shaped outlet (16) actually being the interstice between the front and back crown faces (20), and which is continuously provided under the body (6);
d. the power driving and controlling mechanism (4) comprises a driving motor (22), a reduction gear (23), and a controlling switch (24); and
e. the base (5) is mounted under bottom (8) and comprises: a holder cup (26) which is provided closely together with the bottom and has a trumpet-shaped main part and comprises composite a strengthen laminate (29) closely adhered to the front and back crown face (20) and left and right inclined walls (30) adjacent to left side wall (11) and right side wall (12); a holder neck (27), which is provided under the holder cup (26) and has a main part assuming a tetragonal structure in which has a hollow channel for dropping raw materials (25), and with a controllable baffle (31) for completely cutting off the channel (25) laterally provided between the left and right side walls or the front and back side walls of middle and bottom of it; and a bracket which is provided at the most underneath and is actually an installing base plate (33) with a hole or groove for limiting assembly location (32).

2. The versatile apparatus for evenly mixing and dropping raw materials according to claim 1, characterized in: one of the said left side wall (11) and the said right side wall (12) provides on fixed position with a hole for installing a bearing (34) in which there is a bearing; and the other of the said left side wall (11) and right side wall (12) provides a hole for installing a flange (35) on which the flange plate (36) having a bearing lid (37) and a hole for installing a bearing (34) with the bearing is provided.

3. The versatile apparatus for evenly mixing and dropping raw materials according to claim 1, characterized in: the said short arm blades (18) are staggered on the revolution shaft (17) in the form of propeller.

4. The versatile apparatus for evenly mixing and dropping raw materials according to claim 1, characterized in: the said long arm blades (19) are staggered on the revolution shaft (17), and the working sides of the long arm blades (19) are parallel to the revolution shaft (17).

5. The versatile apparatus for evenly mixing and dropping raw materials according to claim 1, characterized in: the number of the said long arm blades (19) and the said short arm blades (18) is defined depending on request.

6. The versatile apparatus for evenly mixing and dropping raw materials according to claim 1, characterized in: the length of the said long arm blades (19) from its axle center is corresponding to the curvature radius of the front and back crown faces (20).
